(19) United States
(12) Patent Application Publication
(10) Pub. No.: US 2023/0010622 A1
(43) Pub. Date: Jan. 12, 2023

(54) ROTARY VACUUM VESSEL CLOSURE WITH VESSEL CLOSURE SEAL

(71) Applicant: ACTEGA DS GMBH, Bremen (DE)

(72) Inventor: Dany Mängel, Twistringen (DE)

(21) Appl. No.: 17/782,020

(22) PCT Filed: Dec. 10, 2019
(86) PCT No.: PCT/EP2019/084454

§ 371 Date: Jun. 2, 2022

(51) Int. Cl. C08L 53/02; C08L 23/16; C08L 23/14; C08L 25/06

(52) U.S. Cl. CPC C08L 53/025; C08L 23/16; C08L 23/14; C08L 25/06; C08L 53/02; C08L 2205/025; C08L 2205/035

(57) ABSTRACT

The invention relates to a rotary vacuum vessel closure, in particular for fat-containing filling materials, with a vessel closure seal comprising a polymer compound of which the seal consists substantially or entirely: a) wherein the polymer compound is PVC-free and comprises at least one TPS and at least one co-PP, b) and the polymer compound has a Shore A hardness (ASTM D2240, DIN ISO 7619-1) at 70° C. between 30 and 85 and has an MFR (DIN ISO 1133, 5 kg/190° C.) of less than 20 g/10 min.

The invention relates to a PVC-free vessel closure seal according to the generic part of Patent claim 1.

A major problem with polymer-based vessel closure seals is the migration of sealing components into the filling material. Migration problems arise particularly frequently with grease- or oil-containing filling materials since the migrating substances, such as plasticisers and thinners are often fat-soluble.

Larger vessel closures of the type considered here are, in particular, lug closures, which are typically used for the closure of screw-lid glasses for food or beverages. These foods are often fat-containing products such as ready-made foods, sauces, delicatessen, fish in oil, antipasti, spice pastes and the like, whose content of fats or oils increases the risk that fat-soluble components of the packaging material dissolve in the food.

These requirements are also particularly relevant for baby food, which is typically sold in jars with press-on Twist-Off® closures (also referred to here as PT closures or PT caps).

The vessel closures affected here usually have an opening width of at least 35 mm, e.g., 38 mm or more, e.g., 82 mm. Lug closures may have three, four, five or more than five lugs.

Conventional PVC-based vessel closures have favourable sealing properties. On the basis of soft PVC technology, it is also possible to formulate sealants with less migration, which often use polyadipates. Due to their molecular weight, these are less prone to migration when in contact with fat.

The migration is assessed in accordance with the rules defined in Regulation (EU) 310/2011 and DIN EN 1186. Particularly for storage at room temperature, it is postulated that the evaluation after 10 days test time at 40° C. is sufficient to determine the migration. However, analytical practice teaches that with softened PVC in sealing materials, these test conditions are not sufficient, but after several months of storage at room temperature in contact with vegetable oil, migration limits are sometimes significantly exceeded.

It is also undesirable to use PVC-containing compounds in packaging materials. In the usual combustion of household waste, acidic gases are produced from halogenated plastics, the escape of which into the atmosphere is harmful. In addition, even small amounts of PVC interfere with the material recycling of plastic waste. In addition, such PVC-based sealing elements require the use of plasticisers, which are also of concern for reasons of unjustifiable modification of the food and—in the case of the use of epoxidized soybean oil as a plasticiser—the potential formation of toxicologically unevaluated epichlorohydrins. There is therefore a need for PVC-free vessel closure seals that come as close as possible to the favourable properties of the well-known PVC-containing seals.

According to the invention, PVC-free compounds are used. In the product according to the invention, the migration can be largely or completely avoided by the renunciation of liquid components and/or by the use of less migration-prone polymers and other measures.

The migration of components of the packaging (which may also include the sealing insert of the vessel closure where applicable) into the food is not only generally undesirable, but also strictly regulated by legal provisions. Examples of such provisions are EC Regulations 1935/2004, 2023/2006, (EU) 10/2011, including supplements (EU) 321/2011, (EU) 1282/2011, (EU) 1183/2012, (EU) 202/2014, (EU) 174/2015, (EU) 2016/1416, (EU) 2017/752, (EU) 2018/79, (EU) 2018/213, (EU) 2018/831, (EU) 2019/37 and (EU) 2019/1338. Currently, maximum levels of 60 ppm of migrating ingredients are permitted for infant food.

The measurement of the extent of any observed migration where applicable is carried out by means of methods as defined in particular in DIN EN 1186. Such methods are also used in the context of the present invention.

It is not a trivial problem to provide PVC-free sealing inserts for vessel closures of the type under consideration here if these closures have to comply with the above provisions regarding the possible migration of their chemical components. The sealing function must also be guaranteed under filling conditions.

The requirements for the sealing materials for vessel closures for larger inner diameters (of at least 35 mm) of the vessel opening are more demanding because of the relatively larger amounts of material in the seal. For such purposes, it is particularly important to combine a sufficient flowability of the polymer material in the production of the sealing element with sufficient sealing properties in the sealed state; this also includes the tightness required nowadays against the penetration or escape of gases, combined with a pressure-relief-valve effect where applicable, which prevents the bursting of the vessel during heating or the development of overpressure in the vessel for other reasons. In addition, particularly for the typical applications of vessels with larger opening diameters (for example, canned food), it is required that the sealing element can also be used under pasteurization and possibly even sterilization conditions.

With all these characteristics, the seals must also meet the above requirements with regard to the possible migration of chemical components.

A solution to these problems, which has in the meantime been successfully introduced, is disclosed in our application EP 09 756 681, now Patent EP 2 470 435. The seal described there is PVC-free and is based on a combination of at least one olefin block copolymer (OBC) with at least one polyolefin elastomer (POE), high density polyethylene (HDPE) or polypropylene or propylene copolymer ((co-)PP). It should not contain any TPS. The Shore A hardness is between 45 and 95 at room temperature, the compression set is between 30% and 90% at 70° C. The compression set is determined in accordance with EP 2 470 435, as well as in the context of the present invention, according to the standard ASTM D395-Method B. In order to facilitate the processing of compounds known before EP 2,470,435, thinners and/or plasticisers were usually added to them. In particular, liquid components such as extender oils or plasticisers (preferably white oil) were used at application temperature. However, lubricants and liquid components at 20° C. are essentially dispensed with in the known formulation in accordance with EP 2 470 435, since they can promote migration.

The product known from EP 2 470 435 is ideal for many applications but can still be improved for some uses. For example, mechanical sealing processes can lead to severing of the seal if the closing distance is very short and the machine can only be adjusted to a limited extent. With very fast running machines, the evaporation time is sometimes not sufficient to warm up the closure sufficiently.

It would therefore be desirable to have a seal that is thermally and mechanically more stable and yet softer than the seals known from EP 09 756 681. This is intended to achieve easier sealing with a lower risk of severing. This seal should preferably have the advantageous properties of the known seal.

Seals should also have opening values that are as low as possible so that screw closures, such as lug closures (Press-on Twist-Off® closures) and other screw closures can be easily opened. It must be ensured that the closure is not opened unintentionally, which is why the opening value cannot be too low.

With conventional 82 mm Twist-Off® closures, the opening values of PVC-containing seals are often in the range of 4.8-6.2 Nm (42-55 inch/lbs) or higher. Technically complex Orbit® closures, with PVC-based seals with low migration values, designed to reduce the torques required for opening, are less than 4 Nm. With the well-known seal in accordance with EP 09 756 681, typical opening values for Twist-Off® closures are 4.3-5.1 Nm. A lower opening value would be advantageous for PVC-free closures.

The creation of such a seal is an essential object of the invention. In principle, the invention solves these and other problems by means of the feature combinations specified in the independent patent claims.

As with the solution in accordance with EP 09 756 681, the disclosure of which we fully include by reference in the disclosure of this application, the seal of the invention preferably comprises a polymer compound that is introduced in thermally sufficiently flowable form into a closure blank made of metal or plastic, thereby being stamped or the like into the desired shape, which it retains after cooling. In these cases, the finished seal usually consists entirely of the polymer compound. Machines for corresponding manufacturing processes are available from SACMI for example.

The terms “seal”, “seal insert” and “sealing element” are synonymous in the context of this description.

In the case of the vessel closures according to the invention, the sealing element is similarly formed as an insert on the inner surface of the vessel closure, as is also the case with the known crown caps or screw closures.

In principle, in accordance with the manufacturing method according to the invention, a vessel closure blank made of metal is assumed, which is preferably first pre-treated on its inner side with a suitable coating system. In the case of a plastic vessel closure, this pre-treatment is not necessary.

Usually, the coating system consists of a base coat and an adhesive varnish, both of which can be based on an epoxy phenolic resin system or (usually for regulatory reasons) polyesters.

In particular, coating systems of the company ACTEGA Rhenania (base coat TPE279 with adhesive varnish TPE 1500 or ACTEcoat® TPE 515 with ACTEbond® TPE-655-MF), on which the most preferred compounds according to the invention adhere particularly well.

Alternatively, a suitable primer coating can be applied by means of lamination or also possibly by co-extrusion.

On the pre-treated blank in this way, in some preferred embodiments, the polymer material is applied internally in a thermally flowable form to form the seal. In particular, an extrusion is suitable for this, in which the sealing compound is presented at a temperature range between 100° C. and 260° C.

The extrusion can take place approximately in the middle of the blank inner surface if the sealing insert is to be circular disc-shaped. The dosage of the polymer material for extrusion is carried out by stripping a defined amount of the polymer compound from a nozzle. Subsequently, the sealing element is preferably formed from the extruded, still flowable material by appropriate stamping (analogous to the well-known compression moulding method).

Alternatively, the polymer material can be extruded, for example, as a strand and cut be to length appropriately. The strand section thus obtained is then inserted into the preheated closures bank and stamped for sealing insert, if necessary, after further preheating. To increase the adhesion quality, a baking step can follow. The closure is subsequently cooled.

In other preferred embodiments of the invention, a melting ring of sealing material can be extruded, inserted into the blank by means of an applicator and formed into a seal, as described in U.S. Pat. No. 9,409,324 B2.

While, in the case of known bottle closures (crown caps and the like), the sealing element is usually formed as a circular disc on the inner side of the vessel closure, it can be favourable in the case of larger vessel closures like according to the invention to instead form only a ring of polymer material, which lies on the vessel wall in the opening area in the closed state of the vessel.

In a modified form, the sealing element can be formed outside the closure or closure blank by stamping a suitable polymer material and then inserted into the closure or blank. This method is also known by SACMI as outshell-moulding.

As the main component or single component, the material of the sealing insert comprises a polymeric component comprising at least two different polymers, namely at least one TPS and at least one co-PP. The properties of this main polymeric component can be suitably modified by the addition of further components, for example further polymers.

The invention thus detaches itself from the concept known from EP 09 756 681, according to which the desired seal or the polymer compound of the seal must contain an OBC. An OBC can, but does not have to, be contained in the seal according to the invention.

A significant further difference lies in particularly preferred embodiments of the invention in the renunciation of relevant content levels of POEs. Surprisingly, POEs in the well-known seal can be replaced by other polymers.

This renunciation of PO ES helps to solve a problem that occasionally occurs with the known seals: Glass containers are usually finished, for example by coating with PE waxes. Seals with POE content can show a disturbing stickiness when used with such glasses under certain conditions, which increases the opening value of the closure in an undesirable way.

In preferred embodiments of the invention, the seal therefore contains no analytically detectable content of POEs. In other preferred embodiments, a low content of at least one POE may be present, but this is kept so low that the opening value of the seal does not change significantly compared to an identical seal without POE content.

Furthermore, the invention detaches itself from the concept in accordance with EP 09 756 681, according to which the seal or the seal compound may not contain a TPS.

The invention is based on the knowledge that thermally and mechanically stable, but softer generic seals can be obtained if the polymer compound comprises certain types of TPS, in particular SEBS, in combination with certain types of co-PP. Not all known types of TPS and not all known types of co-PP are suitable for this, as will be described below.

In preferred embodiments, the polymer compound according to the invention additionally comprises at least one OBC and/or at least one polyolefin such as a polyethylene, particularly LLDPE for example. The polyolefin can often be replaced by another polymer with similar physical properties. The polymer compound may optionally contain further polymers.

It is preferably provided that the material of the sealing insert has only very low and particularly preferably no contents of components that are liquid at application temperature. The application temperature is usually equal to the ambient temperature, i.e., within the range of usual ambient temperatures outdoors or in heated rooms. Typically, the application temperature is 20° C.

Preferably, therefore, only small or preferably no contents of liquid thinners such as in particular white oil are added to the material of the sealing insert.

Preferably, the material does not contain more than 10%, preferably not more than 7%, in particular, not more than 4% or even not more than 1% of lubricants—in particular, those which pass into the fat-containing filling material in a limited manner during a migration test at 40° C. for 10 days (percentages are always weight percentages in this application based on the total weight of the compound in the seal unless expressly stated otherwise).

Polymer compounds according to the invention generally have a Shore A hardness (ASTM D2240, DIN ISO 7619-1) between 30 and 85 at 70° C., more specifically a Shore A hardness between 40 and 75. The lower the hardness, the easier it is to attach the closures. When used on steam-vacuum capping machines, there is an increased risk of severing if the hardness is below Shore A 30 at 70° C. Above Shore A 85, there is an increased risk that sealing will not be successful. When used on cold vacuum sealing machines without preheating, no vacuum is achieved at a Shore A hardness above 85.

Preferably, the compression set of the polymer compound (23° C., ASTM D395-97 Method B) is a maximum of 50%, more preferably at a maximum of 40% m and, particularly preferred, at a maximum of 30%. The compression set can be 25% and below in optimized embodiments.

The polymer compound preferably has a relatively high viscosity in the melt, meaning a melt mass flow rate (MFR) in accordance with DIN ISO 1133 at a 5 kg weight and 190° C. measuring temperature of less than 20 g/10 min., or better, less than 15 g/10 min.

Particularly for processing on cold vacuum capping machines, it may be useful to select other viscosities.

After sealing, during and after the cooling process and often also during the storage of the sealed container, PVC-free compounds are subject to crystallization processes in the polymer compound. These influence the hardness and elasticity of the seal, thus the tension between the closure and the container, and the migration of the lubricant on the surface of the seal. The slower the crystallization, the lower the tension because the polymer compound has more time to relax. The smaller the crystalline content in the compound, the more favourable the migration of the lubricant.

The crystallinity of the polymer compound can be measured using known methods that provide values for crystallinity area, start and end of the crystallization process and maximum crystallinity.

The peak crystallization temperature and the crystallization enthalpy related to the weight is determined by DSC measurement (dynamic scanning calorimetry) from the first cooling curve. The rules for this are described in ISO 11357 standard or its subchapters (in particular 15011357-3). The quantities were measured using a DSC1 system from Mettler Toledo.

It has proven helpful in describing the suitability of a sealing material for vacuum screw closures to design polymer compounds in such a way that the temperature of the exothermic peak is higher than the expected maximum operating temperature of the vessel closure. This exothermic peak temperature from the crystallization process is often well below the temperature of the endothermic melt peak.

Basically, the invention prefers the use of such polymers having low crystallization enthalpies, while particularly crystalline polyolefins such as homo-PP, LLDPE, LDPE and HDPE are preferably not used or only to a reduced extent.

Preferred polymer compounds have a specific total crystallization enthalpy above room temperature of less than 50 J/g, more preferably a maximum of 40 J/g, more preferably a maximum of 30 J/g.

The TPS used according to the invention are preferably SEBS. Linear SEBS with styrene content levels between 26% and 34%, particularly between 29% and 33% are generally preferred. SEBS with 31% to 32% styrene are usually most preferred.

Particularly preferred SEBS are linear triblock copolymers of type S-E/B-S. Products such as KRATON® G1651 and CALPRENE® 6174 are particularly suitable. SEBS polymers with styrene content levels lower than 25 wt. and, simultaneously, low molecular weights than the above-mentioned reference materials can be used in the mixture with KRATON® G1651 to increase the flexibility and flowability of the compound (in the sense of a plasticiser instead of white oil).

Other TPS that can be used instead of or in conjunction with SEBS include SEEPS, Polybutene, and similar TPS.

Preferred polymer compounds generally comprise up to 60%, more specifically up to 55%, more preferably up to 50% TPS. Preferably, such polymer compounds comprise at least 1%, specifically at least 5% and more preferably at least 10% TPS. Other preferred embodiments comprise at least 20%, more preferably at least 30% and usually, preferably at least 40% TPS.

Preferred TPS generally have styrene content levels of 28 to 35%. A 10% solution in toluene has a viscosity of less than 2.5 Pa·s, measured with a Brookfield LVT viscometer. The density is preferably between 0.90 and 0.93 g/ccm.

TPS are not in themselves particularly suitable polymers for sealing compounds that come into contact with fat-containing or oily fillers because they facilitate the entry of greases and oils into the seal. This is particularly true for products that are thermally treated, e.g., pasteurized or sterilized. In accordance with EP 09 756 681, it is necessary to dispense with TPS contents in the polymer compound to the furthest extent possible.

However, it has surprisingly turned out that TPS can also be successfully used in sealing compounds for applications in greases and oils if the polymer compound contains certain polypropylene copolymers (co-PP). Apparently, the co-PP content prevents the absorption of fats and oils through the seal even in the presence of TPS and also in pasteurization and even sterilization (up to temperatures of 132° C.). This may also be possible with the use of homo-PPs, which, however, do not lead to the required physical properties of the seal in such TPS-based compounds. Homo-PPs are therefore not used in favoured embodiments of the invention in place of co-PPs.

Preferred co-PPs have a Shore D hardness of less than 55, preferably below 45, more preferably below 40. The Shore D hardness is preferably greater than 15, being better, greater than 20, more preferably greater than 30.

The MFR of the co-PP is preferably at 2.16 kg and 230° C. measuring temperature at less than 30 g/10 min, more preferably at less than 20 g/10 min and even more preferably below 10 g/10 min.

Particularly preferred are co-PPs with an MFR (2.16 kg/230° C.) of at least 0.1, more specifically at least 0.3 and even more specifically at least 0.5, and a maximum of 15, more specifically a maximum of 12 and even more specifically a maximum of 10.

The melting point of the co-PP is preferably below 165° C., more preferably at below 160° C., most preferably at below 150° C.

The amount used of co-PP in the compound is preferably generally 5%-265%. Higher content levels are possible.

The co-PP preferably has a low crystallinity at a relatively high melting point. Preferred co-PPs have a total crystallization enthalpy of less than 50 J/g, at melting points above 135° C., or even above 160° C.

Particularly suitable products can be found in the portfolio of the LyondellBasell ADFLEX series or at Mitsui Chemicals in the TAFMER series. VISTAMAXX types from ExxonMobil are also suitable.

In preferred embodiments of the invention, the co-PP can be partially replaced by other polymers, for example by LLDPE.

The polymer materials can withstand hot filling of up to 100° C. for up to 60 min.

Optionally, pigments, preferably inorganic pigments, can also be added to the formulations of the compounds to exclude pigment migration. It has also been shown that other additives such as (unsaturated) fat-containing acid amides, waxes, silicones and other common additives can be added to the polymer compounds in order to improve, for example, processing and performance properties.

In the following, exemplary embodiments of the invention are described on the basis of the composition of the polymer compounds from which the vessel closure seal according to the invention was formed as stated above:

### Exemplary Embodiment 1

40% co-PP
10% SEBS
47% OBC
3% lubricant

### Exemplary Embodiment 2

30% co-PP
40% SEBS
30% LLDPE

### Exemplary Embodiment 3

60% co-PP
40% SEBS

1. Rotary vacuum vessel closure suitable for fat-containing filling materials, comprising a vessel closure seal comprising a polymer compound, of which the seal consists essentially or entirely,
a) wherein the polymer compound is PVC-free and comprises at least one TPS and at least one co-PP,
b) and the polymer compound has a Shore A hardness (ASTM D2240, DIN ISO 7619-1) between 30 and 85 at 70° C. and an MFR (DIN ISO 1133, 5 kg/190° C.) of less than 2.0 g/10 min, and
(c) does not contain more than 10% of liquid constituents at 20° C.

2. Rotary vacuum vessel closure according to claim 1, in which the polymer compound substantially does not comprise a POE.

3. Rotary vacuum vessel closure according to claim 1, in which the polymer compound substantially does not comprise a homo-PP.

4. Rotary vacuum vessel closure according to claim 1, in which the polymer compound comprises at least one SEBS, SEEPS or polybutene.

5. Rotary vacuum vessel closure according to claim 1, in which the polymer compound comprises a linear SEBS with styrene content levels between 20% and 40%.

6. Rotary vacuum vessel closure according to claim 1, in which the polymer compound comprises at least 1%.

7. Rotary vacuum vessel closure according to claim 1, in which the polymer compound comprises a TPS with a Shore A hardness (ASTM D2240, DIN ISO 7619-1) from 50 to 90 at 23° C.

8. Rotary vacuum vessel closure according to claim 1, in which the polymer compound comprises a co-PP having a Shore D hardness (ASTM D2240, DIN ISO 7619-1) of less than 55 at 23° C.

9. Rotary vacuum vessel closure according to claim 1, in which the polymer compound comprises a co-PP having an MFR of less than 30 g/10 min measured at 2.16 kg/230° C.

10. Rotary vacuum vessel closure according to claim 1, in which the polymer compound comprises a co-PP with an MFR (2.16 kg/230° C.) of at least 0.1.

11. Rotary vacuum vessel closure according to claim 1, in which the polymer compound comprises a co-PP with a melting point below 165° C.

12. Rotary vacuum vessel closure according to claim 1, in which the polymer compound comprises between 1% and 80%.

13. Rotary vacuum vessel closure according to claim 1, in which the polymer compound further comprises LLDPE.

14. Rotary vacuum vessel closure according to claim 1, in which the polymer compound does not contain more than 10%, of lubricants.

15. Rotary vacuum vessel closure according to claim 1, in which the polymer compound does not contain more than 7% of liquid components at 20° C.

16. Rotary vacuum vessel closure according to claim 1, which is pasteurizable.

17. Rotary vacuum vessel closure according to claim 1, showing vacuum retention.

18. Rotary vacuum vessel closure according to claim 1, in which the polymer compound has a compression set (ASTM D395-97 Method B) of a maximum of 50% at 23° C.
